(19) United States
(12) Patent Application Publication
(10) Pub. No.: US 2012/0084649 A1
(43) Pub. Date: Apr. 5, 2012

(54) Journal System

(76) Inventors: Catherine D. Dowdell, Caledonia, WI (US); Lillard Wells Culver, III, Mequon, WI (US); David Ratfelders, Mequon, WI (US); John R. Weaver, Waukesha, WI (US)

(21) Appl. No.: 12/896,663

(22) Filed: Oct. 1, 2010

(51) Int. Cl. G06F 3/048

(52) U.S. Cl. 715/709

(57) ABSTRACT

A journal system for promoting a person's personal growth and a method of guiding journal entries are provided. The journal system includes a journal page configured to receive entries from a user and a plurality of repositionable guides. Each repositionable guide of the journal system includes a different intention to assist the user in making an entry on the journal page. The repositionable guides are individually positionable on the journal to provide the intention. The journal system also includes a storage location for the plurality of repositionable guides. The storage location is separate from the journal page so that the plurality of repositionable guides are not viewable on the journal page until the selected one of the plurality of repositionable guides is positioned on the page by the user.

### FIELD OF THE INVENTION

The present invention is directed to a journal system and method of guiding journal entries, and more particularly to a journal system and a method of guiding journal entries for promoting a journal user's personal growth.

### BACKGROUND OF THE INVENTION

The demands of contemporary living require constant attention throughout the day. Daily life activities include work, family, socializing and more. The constant juggling of other people's needs in addition to one's own needs leaves little time for one's self. These activities may become detrimental to one's personal growth, for example when the to do lists become too long, the challenges seem insurmountable, concentration or focus is lost due to competing needs, personal fulfillment is lacking or similar issues.

There is a need to make the daily life activities more meaningful and to promote personal growth to facilitate wellness and balance in daily life. Daily activities or any life activities can become more meaningful when a person is connected to awareness. A guiding system to help direct one's thoughts toward awareness is beneficial to promote personal growth.

Many people may be unsure about which of the numerous exercises, products, or personal growth systems are best suited to fit their particular needs. Moreover, one exercise or product may be effective on one occasion, but not another occasion, leading a person to be frustrated with their choices and progress in personal growth and abandon the practice altogether. Additionally, because feelings and needs may vary, one may not want to be tied down to a particular exercise, product, or system that is suited for a particular feeling, such as stress. Online meditations may be convenient, but may lack any features that tailor the experience to a particular user.

One way to become more aware is to journal or to write about daily life activities. For new journal users or for users needing some direction to begin journaling, a blank journal page may make the journaling experience too difficult to begin.

What is needed is a journal system for promoting personal growth that provides the user with a prompt to facilitate the journaling process. A journal system is needed that guides the journal user by providing a prompt for the journal user to consider for facilitating awareness and to provide guidance for the journal entry to promote personal growth.

### BRIEF SUMMARY

A journal system for promoting a person's personal growth and a method of guiding journal entries are provided. The journal system includes a journal page configured to receive entries from a user and a plurality of repositionable guides. Each repositionable guide of the journal system includes a different intention to assist the user in making an entry on the journal page. The repositionable guides are individually positionable on the journal page to provide the intention. The journal system also includes a storage location for the plurality of repositionable guides. The storage location is separate from the journal page so that the plurality of repositionable guides are not viewable on the journal page until the selected one of the plurality of repositionable guides is positioned on the page by the user.

### BRIEF DESCRIPTION OF THE DRAWINGS

FIG. 1 is a perspective view of an embodiment of a journal system;

FIG. 2 is a plan view of a page of an embodiment of the journal system;

FIG. 3 is a plan view of a repositionable guide of an embodiment of the journal system;

FIG. 4 is a plan view of the repositionable guide positioned on the page of an embodiment of the journal system;

FIG. 5 illustrates the intentions, the associated symbols, colors and scents of an embodiment of the journal system;

FIGS. 6A and 6B are plan views of additional pages of an embodiment of the journal system;

FIGS. 7A and 7B are plan views of a foldable page of an embodiment of the journal system;

FIG. 8 is a plan view of an instruction page of an embodiment of the journal system; and

FIG. 9 is a screen shot of an embodiment of the journal system.

### DETAILED DESCRIPTION

The invention is described with reference to the drawings in which like elements are referred to by like numerals. The relationship and functioning of the various elements of this invention are better understood by the following detailed description. However, the embodiments of this invention are not limited to the embodiments illustrated in the drawings. It should be understood that the drawings are not to scale, and in certain instances details have been omitted which are not necessary for an understanding of the present invention, such as conventional fabrication and assembly.

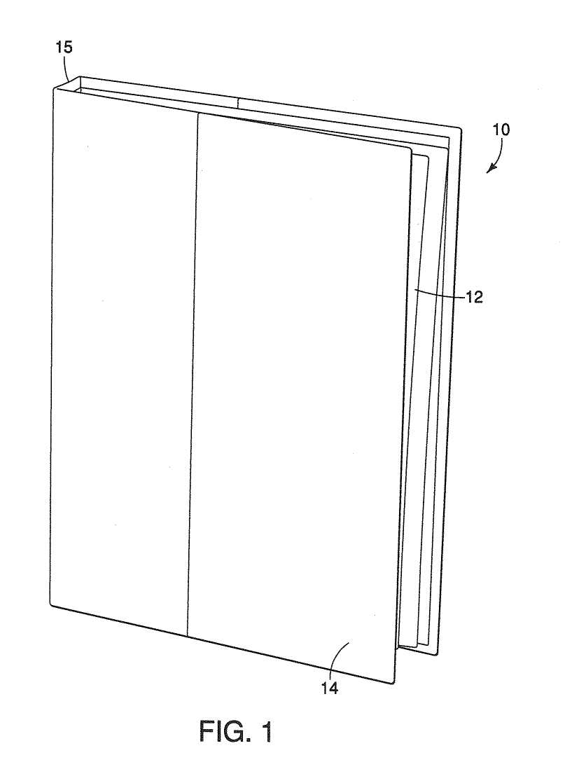

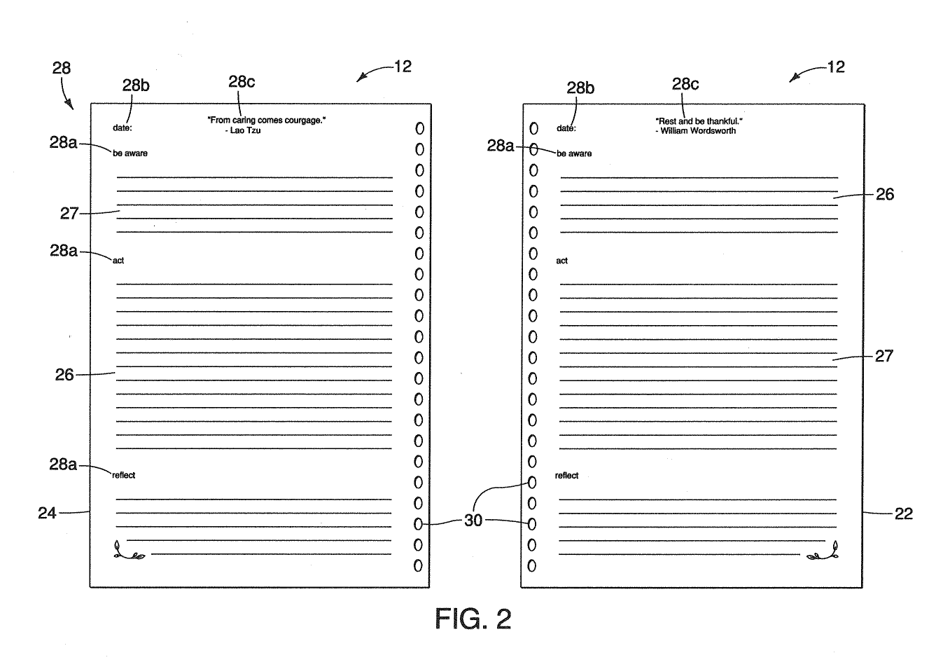

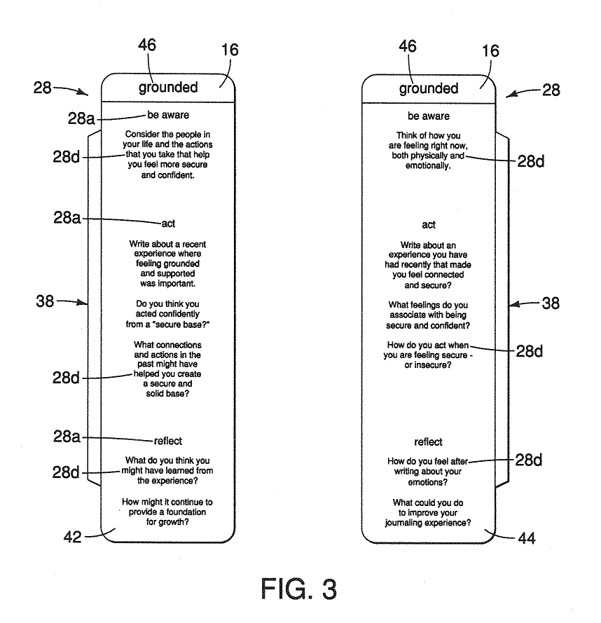

FIG. 1 illustrates an embodiment of the journal system 10. The journal system 10 may include one or more pages 12 and a cover 14. FIG. 2 illustrates an exemplary page 12 in more detail. The journal system 10 further includes one or more repositionable guides 16 as illustrated in FIG. 3. The repositionable guides 16 may be positionable on the page 12 to facilitate the journal user in making an entry as explained in more detail below.

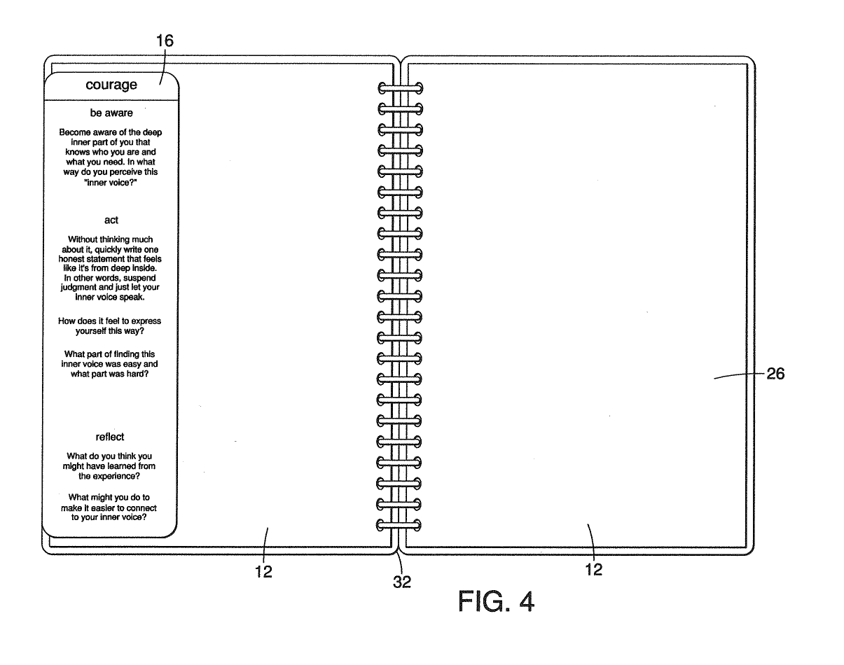

FIG. 2 illustrates the page 12 of the journal system 10 having a first side 22 and a second side 24. The page 12 includes a writable portion 26 that may include lines 21 or may have open space on the page 12 to receive user entries. The page 12 may also include a written content portion 28. By way of non-limiting example, the written content portion 28 may include a prompt 28a to help direct the journal user's entry. The written content portion 28 may also include a “date” portion 28b so the journal user can record the date of the entry. The written content portion 28 may also include an inspirational message or a quotation 28c. Each page 12 may include a different inspirational message or a quotation 28c. The page 12 may also include a plurality of holes 30 so that a plurality of pages 12 may be provided together within the cover 14 and held together, for example using one or more wires 32 through the holes 30. (See FIG. 4, showing an exemplary bound journal system. The pages 12 may be removably bound in the cover 14 or may be non-removably bound in the cover 14. In some embodiments, additional pages 12 may be added. In some embodiments, the pages 12 may be bound together without the use of holes 30, for example by gluing or sewing the pages 12 together. The page 12 may be any size and shape. In some embodiments, the page 12 may be sized to be easily carried by the user so that the journal system 10 is readily available. By way of non-limiting example, the page 12 may be about 5×7 inches (12.7×17.8 cm), about 5×8 inches (12.7×20.3 cm), about 6×8 inches (15.2×20.3 cm) or about 5.5×7.6 inches (14×19.3 cm). Other sizes for the page 12 may also be used. The cover 14 may be sized slightly larger than the page 12 and may include a spine 15 so that a plurality of pages 12 fit within the cover 14.

As shown in FIG. 2, the written content portion 28 on the page 12 may include the prompt 28a to the user to assist the user in making an entry onto the writable portion 26. The page 12 may include one or more prompts 28a instructing the user to “be aware,” “act” and/or “reflect.” By way of non-limiting example, the “be aware” prompt 28a may be used to prompt the user to be more self-aware, recognizing emotions and the affect of the emotions on the user and prompt the user into personal growth. The “act” prompt 28a may be used to prompt the user to choose actions through awareness rather than just reacting with emotions. The “reflect” prompt 28a may be used to prompt the user to reflect on the user's actions and grow from the knowledge gained. The user may make entries on the writable portion 26 in response to one or more of the prompts 28a.

An exemplary repositionable guide 16 of the journal system 10 is shown in FIG. 3. The repositionable guide 16 is separately provided from the page 12 and may be positioned on the page 12 as shown in FIG. 4. The repositionable guide 16 may be positioned anywhere on the page 12 by the journal user to help guide the user in making a journal entry in the writable portion 26. In some embodiments, the repositionable guide 16 may include a tab 38 or a plurality of holes (not shown) to help hold the repositionable guide 16 on the page 12. For example, the tab 38 may be folded over the page 12 or the plurality of holes may be connected to the wire 32 for removably connecting the repositionable guide to the page 12. In some embodiments, the repositionable guide 16 is similar to a bookmark and is placed on the page 12 without connecting the repositionable guide 16 to the page.

The repositionable guide 16 of the journal system 10 includes a first side 42 and a second side 44. Either the first side 42 or the second side 44 may be displayed to the journal user when positioned on the page 12. In some embodiments, the first side 42 and the second side 44 may include written content 28 that may be the same or different. The first side 42, the second side 44 or both may include one or more of the prompts 28a to “be aware,” “act” and “reflect.” The first side 42, the second side 44 or both may include additional written content 28d to further prompt the journal user by providing additional suggestions to the user to facilitate the journal entries.

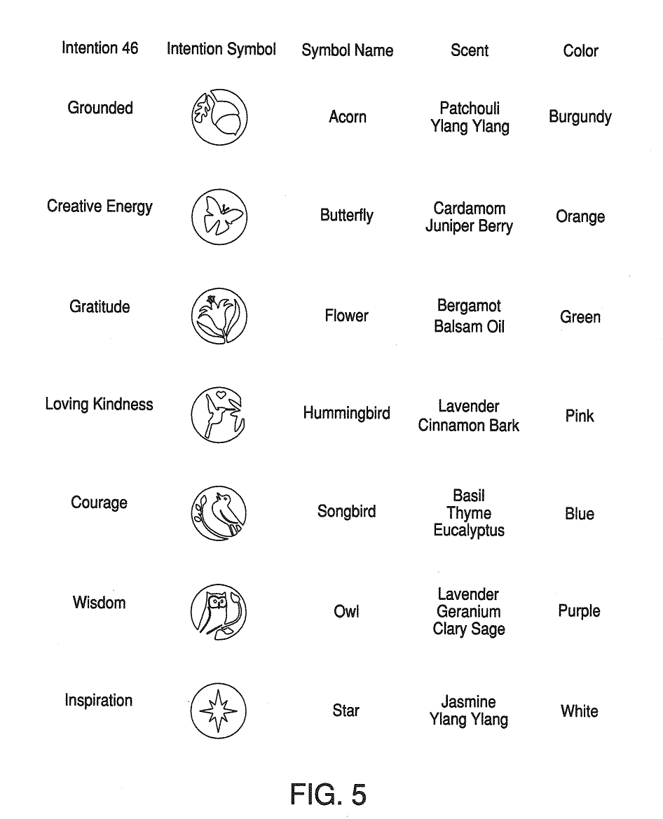

The first side 42, the second side 44 or both may include an intention 46 that may be represented by a word, a color, a symbol or any combination thereof. The intention 46 is based on a determination to act in a certain way. The intention 46 is informed by western psychology and inspired by Buddhist teachings and includes, but is not limited to the following: grounded, creative energy, gratitude, loving kindness, courage, wisdom, and inspiration. The symbols and colors for each intention 46 in this embodiment are shown in FIG. 5. Each intention 46 may also have a scent associated with the intention 46 to further facilitate the user's ability to make journal entries. The scent may be provided in the form of a candle, a scented card or the like and may be used during the journaling process. As shown in FIG. 5, the grounded intention may be symbolized by the acorn, the scent associated with the grounded intention may include patchouli and ylang ylang and the color may be burgundy. The creative energy intention may be symbolized by the butterfly, the scent associated with the creative intention may include cardamom and juniper berry and the color may be orange. The gratitude intention may be symbolized by the flower, the associated scent may include bergamot and balsam oil and the color may be green. The loving kindness intention may be symbolized by the hummingbird, the associated scent may include lavender and cinnamon bark and the color may be pink. The courage intention may be symbolized by the song bird, the associated scent may include basil, thyme and eucalyptus and the color may be blue. The wisdom intention may be symbolized by the owl, the associated scent may include lavender, geranium and clary sage and the color may be purple. The inspiration intention may be symbolized by the star, the associated scent may include jasmine and ylang ylang and the color may be white. Additional intentions 46 may also be used with the journal system 10 and may include their own symbol, scent and color.

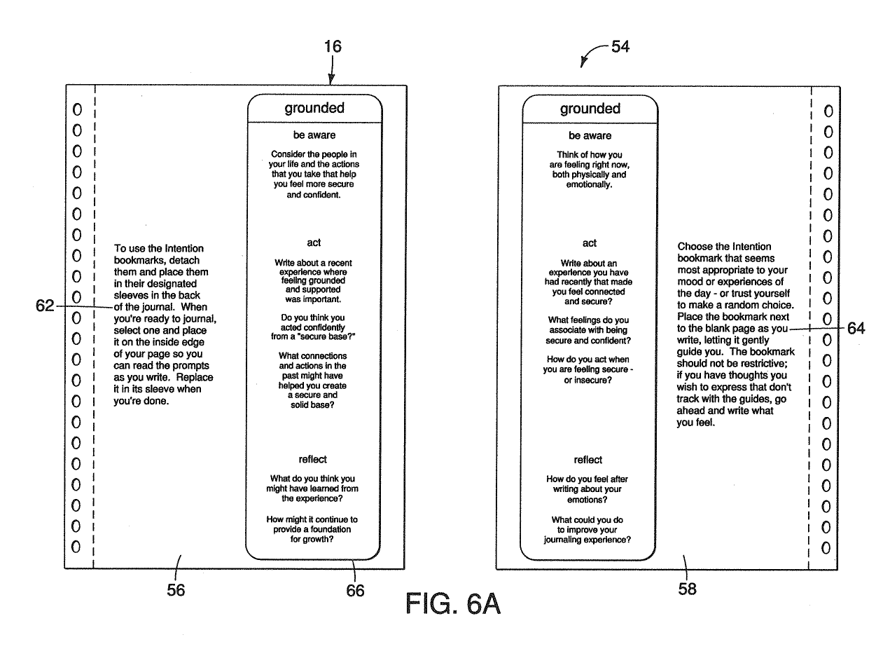

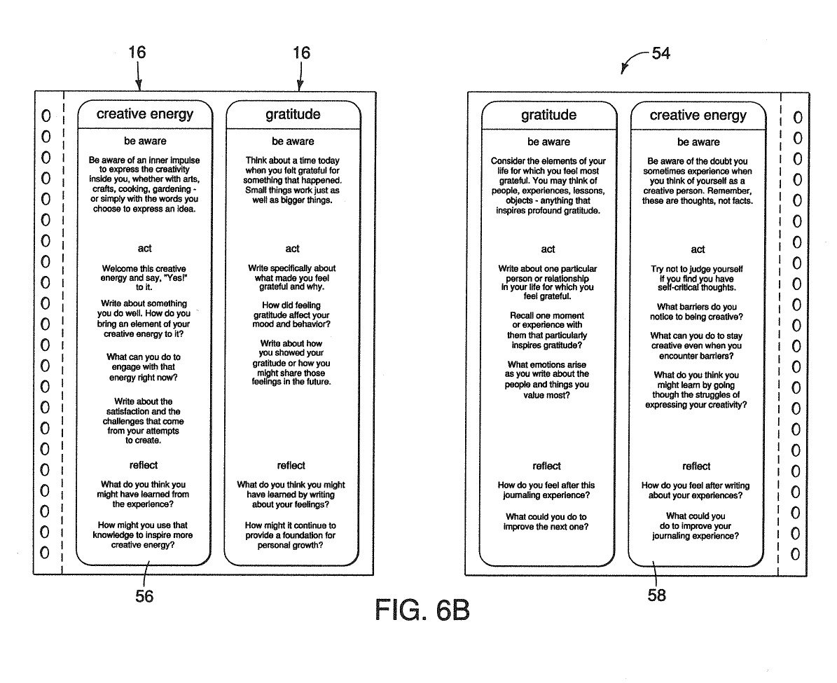

In some embodiments, the repositionable guides 16 may be provided attached to additional pages 54 of the journal system 10, each additional page 54 having a first side 56 and a second side 58 as shown in FIGS. 6A and 6B. One or more of the additional pages 54 may include instructions 62 for removing the repositionable guides 16 from the additional pages 54. One or more of the additional pages 54 may include instructions 64 for selecting the appropriate repositionable guide 16 based on the journal user's mood or experiences of the day and for positioning the repositionable guide 16 on the page 12. One or more of the additional pages 54 may include a plurality of repositionable guides 16, see for example, FIG. 6B. The repositionable guides 16 may be removed from the additional pages 54 by detaching the repositionable guides 16. By way of non-limiting example, repositionable guides 16 may be removed by separating the repositionable guides at perforations 66 around the periphery of the repositionable guide 16, by cutting or by removing an adhesive. Other methods for removably connecting the repositionable guides 16 to the additional pages 54 may also be used.

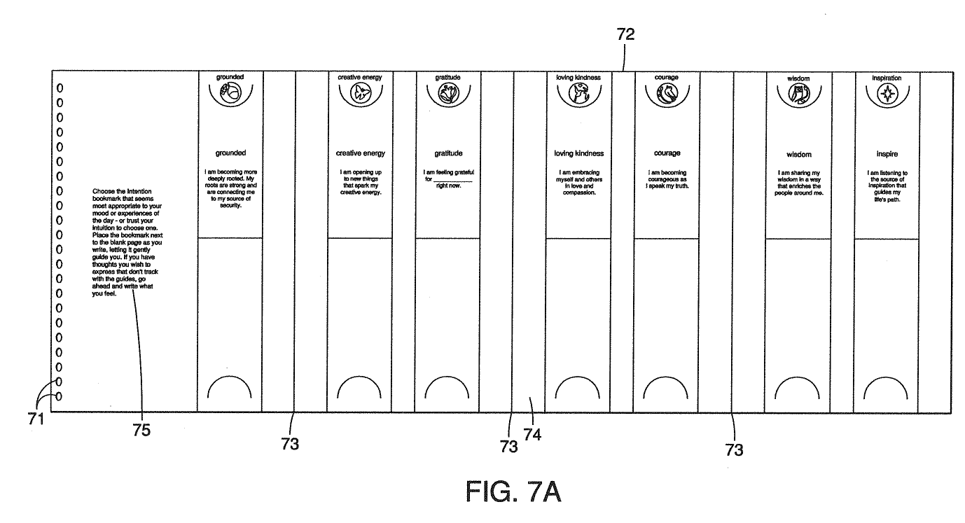

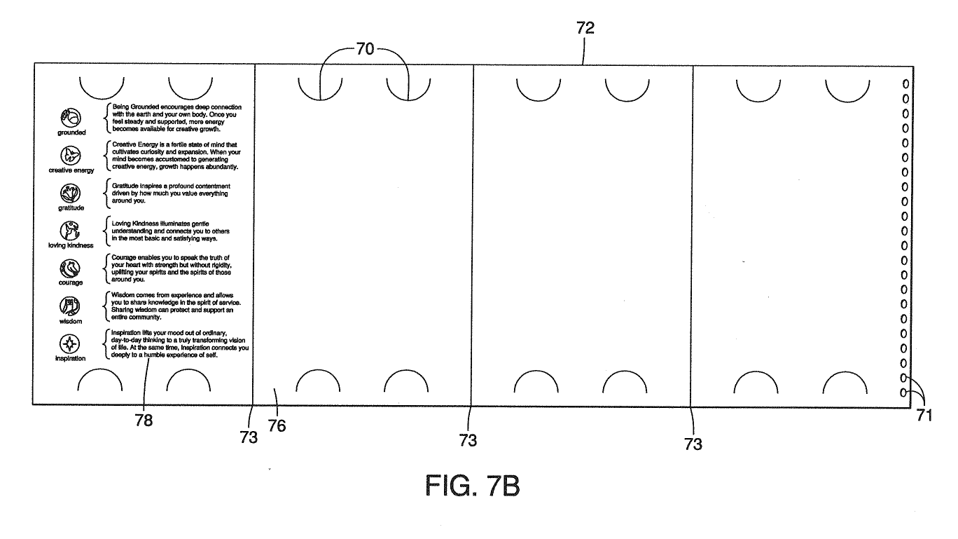

Once the repositionable guides 16 are removed from the additional pages 54, the repositionable guides 16 may be stored with the journal system 10. In some embodiments, the repositionable guides 16 may be stored in a plurality of holders 70 provided on a foldable page 72 as shown in FIGS. 7A and 7B. The foldable page 72 may include a plurality of holes 71 to connect the page 72 to the other pages 12 and the cover 14, for example with the wire 32. The page 72 may be folded along the lines 73 so that the foldable page 72 fits within the cover 14 of the journal system 10. The foldable page 72 includes a first side 74 and a second side 76. In some embodiments, the holders 70 may be provided as a sleeve into which the repositionable guides 16 may be slid for storage. The sleeves may be made of clear material so that the journal user may readily select the repositionable guide 16 having the intention 46 thereon to help guide the user to make one or more journal entries. In some embodiments, the first side 74 may include illustrations of the repositionable guides 16 with the intention 46 indicated by word, symbol, color or combinations thereof to facilitate the journal user's selection of the appropriate repositionable guide 16. The first side 74 may also include instructions 75 to assist the journal user in selecting the appropriate repositionable guide 16. The second side 76 of the page 72 may include a plurality of holders 70, for example, configured as a pair of tabs for holding the repositionable guide 16. The page 72 may include a sufficient number of holders 70 to hold all the different intentions 46 on the repositionable guides 16. The second side may also include words, symbols, colors or combinations thereof for each of the intentions 46. The holders 70 are configured to removably hold the repositionable guides 16 so that the user may select one repositionable guide 16, use the repositionable guide 16 to facilitate the journaling, and return the repositionable guide 16 to the holder 70.

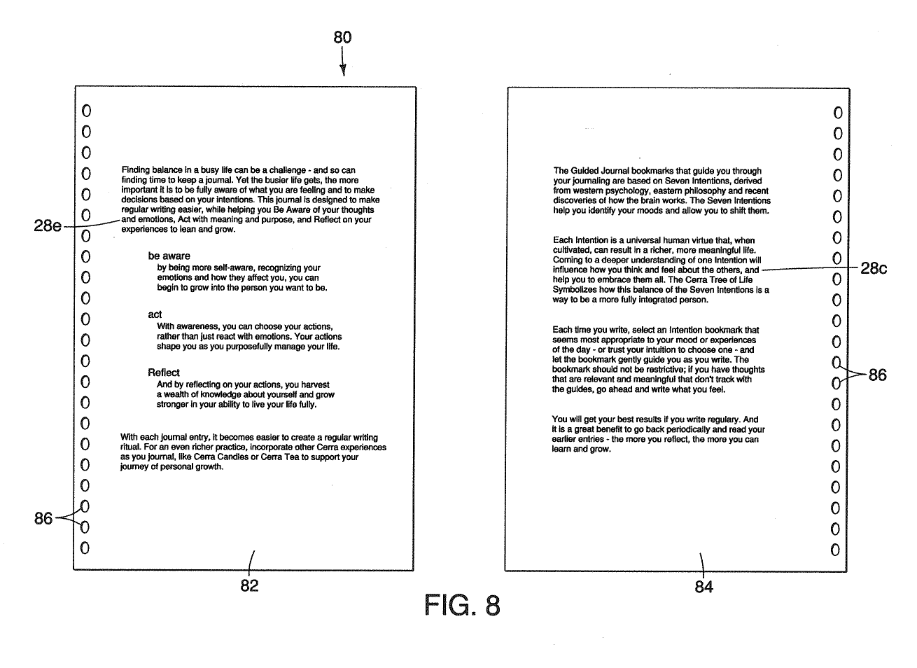

In some embodiments, the journal system 10 may also include one or more instruction pages 80 as shown in FIG. 8. The instruction page 80 may include a first side 82, a second side 84 and a plurality of holes 86. The instruction page 80 may include written content 28e providing instructions to the journal user on how to use the journal system 10.

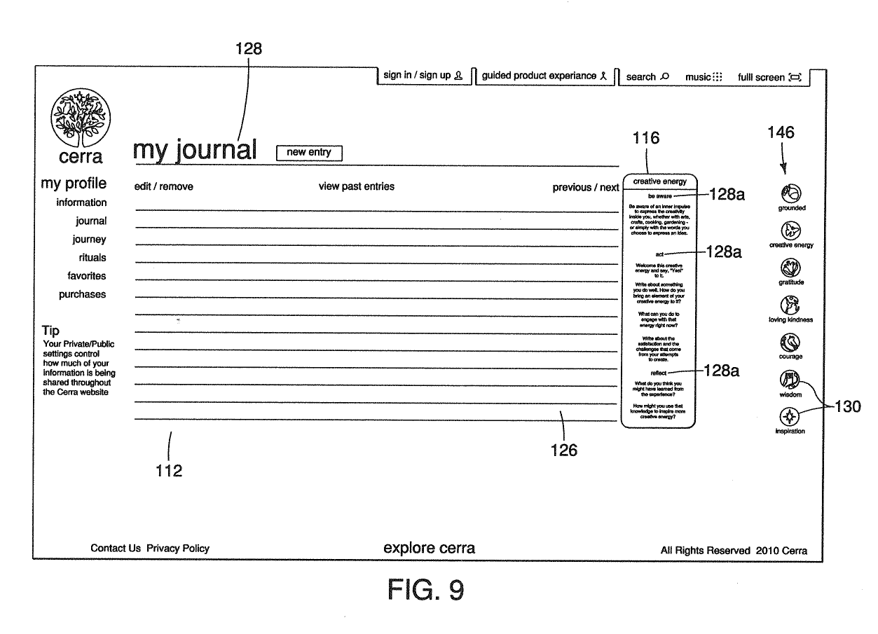

The system 10 may be implemented electronically. For example, the pages, covers, writable portions, repositionable guides, and other elements of the system 10 may be implemented with instructions and data (e.g., in the form of journal software) stored in memory and executed and accessed by a processor of a home computer, cell phone, smart phone, or other device. When executed, the journal software may render images on a display to represent the physical elements of the system 10 (e.g., the pages). The journal software may further interact with a user to accept keyboard, mouse, voice, and other input to manipulate the journal, such as by opening the journal (e.g., with a mouse click), selecting repositionable guides (e.g., from a guide selection menu), positioning the guides (e.g., by dragging the mouse), and accepting keyboard input to enter notes into the journal pages. FIG. 9 shows one example of an electronic journal system 10 that includes an electronic page 112 having an electronically writable portion 126 in which the user may type journal entries. The journal system 10 includes descriptive labels 128 that provide explanations of how the journal is used, explanations of which areas of the journal provide which functionality, or any other desired guidance to the journal user. The journal software 10 also generates a guide selection menu 146 including one or more icons 130, any of which may be associated with an intention (e.g., the intentions 46), and any of which may be selected (e.g., by a mouse click). The journal software may respond to a mouse click on an icon 130 by displaying an associated repositionable guide 116 appropriate for the selected icon 130. Each repositionable guide 116 may be positioned (e.g., by dragging it with the mouse) onto the electronic page 112, where the user may enter text (e.g., by keyboard or voice recognition input). In some implementations, the journal software may limit selection and placement of the repositionable guides 116 individually, although in other implementations, multiple repositionable guides 116 may be selected and placed at the same time. Each repositionable guide 116 may include one or more descriptive labels 128a, such as: “be aware,” “act” and “reflect”, or other descriptive labels to encourage the user to take certain steps in pursuit of the selected intention.

The journal system 10 may be provided to ease the user into the journaling experience. Use of the journal system 10 will be described with reference to the journal system 10. By way of non-limiting example, the specific intention 46 of courage will be described. The journaling experience described below may be achieved for any for the seven intentions 46 using the journal system 10, but is not limited to these seven intentions described herein. The pages 12 may be provided to the user in the cover 14 with the additional pages 54 and the instruction page 80 also provided. The journal user may initially remove the repositionable guides 16 from the additional pages 54 and store the repositionable guides 16 in the holders 70 of the foldable page 72.

To begin the journaling experience, the user removes the selected repositionable guide 16 from the holder 70 and places the repositionable guide 16 on the page 12 as shown in FIG. 4. The repositionable guide 16 is selected based on the journal user's mood or experiences of the day or by intuition. The user reads the repositionable guide 16 and places a journal entry on the writable portion 26 of the page 12. The journal user may use the prompts 28 on the repositionable guide or may enter any other thoughts on the writable portion 26. At any time during the journaling experience, the user may re-read previous entries. Once the journal entry is complete, the journal user may return the repositionable guide 16 to the holder 70. The user may repeat the journaling experience multiple times, each time journaling on a new page 12 and selecting a new repositionable guide 16 or the same repositionable guide 16.

The journal system 10 may be manufactured using a variety of manufacturing techniques. For example, the pages 12 may be made of any suitable material for receiving a written entry from a journal user, for example paper. The written content 26 may be printed on the pages 12. The additional pages 54 may be manufactured to include the repositionable guides 16, for example by printing the prompts 28 on a portion of the additional page 54 and creating a perforated edge around the repositionable guide 16 for later removal by the journal user. Alternatively, the removable guide 16 may be manufactured separately and adhered to the additional page 54 using an adhesive for later removal by the journal user. Additional methods of manufacturing the additional pages 54 may be employed. The holders 70 may be manufactured and provided on a foldable page 72. The holders 70 may be provided as tabs for removably securing the repositionable guides therein. In some embodiments, the holders 70 may be provided as sleeves on the foldable page 72. The foldable page 72 is folded so that a portion of the holder is exposed to the journal user, the portion showing a plurality of intentions 46.

The pages 12, the additional pages 54 and the foldable page 72 having the holders 70 may be punched to include the plurality of holes 30. The pages 12, the additional pages 54 and the foldable page 72 may be assembled together by providing a wire through the holes 30 and connecting the wire to the cover 14. Alternatively, the pages 12, the additional pages 54 and the foldable page 72 may be assembled together with the cover by gluing or sewing or other methods.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A journal system for promoting a person's personal growth, the journal system comprising:
a journal page configured to receive entries from a user;
a plurality of repositionable guides, each guide comprising a different intention to assist the user in making an entry on the journal page, the plurality of the guides individually positionable on the journal page to provide the intention; and
a storage location for the plurality of repositionable guides, the storage location being separate from the journal page so that the plurality of guides are not viewable on the journal page until the selected one of the plurality of guides is positioned on the page by the user.

2. The journal system of claim 1, wherein each guide further comprises one or more prompts.

3. The journal system of claim 2, wherein the prompt comprises an instruction to “be aware,” “act” or “reflect.”

4. The journal system of claim 1, wherein the intention comprises grounded, creative energy, gratitude, loving kindness, courage, wisdom or inspiration.

5. The journal system of claim 1, wherein each of the plurality of guides is removably storable in a corresponding holder positioned on an inner face of a cover of the journal system.

6. The journal system of claim 1, wherein the journal system comprises at least one folding portion that is unfoldable to display the plurality of guides to the user.

7. The journal system of claim 1, wherein the plurality of guides are initially removably attached to one or more pages of the journal system.

8. The journal system of claim 1, wherein the journal system comprises instructions for selecting one of the plurality of guides.

9. The journal system of claim 1, wherein each journal page includes a written content portion.

10. The journal system of claim 1, wherein each journal page includes one or more journal page prompts comprising “be aware,” “act” or “reflect.”

11. The journal system of claim 1, wherein each of the plurality of guides comprises a different color.

12. The journal system of claim 1, wherein the one of the plurality of guides is positionable on the journal page so that the user is able to make an entry on the page with the guide viewable to suggest an instruction.

13. A journal system for promoting a person's personal growth, the journal system comprising:
a journal page, the page comprising a written content portion and a writable portion to receive user entries;
a plurality of repositionable guides, each guide comprising a prompt to assist the user in making an entry on the journal page, the plurality of the guides individually positionable on the journal page to provide the prompt; and
a storage location for the plurality of repositionable guides, the storage location being separate from the journal page so that the plurality of guides are not viewable on the journal page until the selected one of the plurality of guides is positioned on the page by the user.

14. The journal system of claim 13, wherein each guide comprises an intention.

15. The journal system of claim 13, wherein the prompt comprises “be aware,” “act” or “reflect” or combinations thereof.

16. A method of guiding a user to use a journal, the method comprising:
providing an instruction to the journal user to select a repositionable guide and position the guide on a page of the journal system;
after the user selects a repositionable guide, providing an instruction on the repositionable guide for the journal user to be aware;
providing an instruction on the repositionable guide for the journal user to act by writing an entry in the journal; and
providing an instruction to reflect.

17. The method of claim 16, providing a plurality of repositionable guides positionable on a journal page, each repositionable guide comprising an intention.

18. The method of claim 17, comprising guiding the user by providing the intention on the repositionable guide, the intention comprising grounded, creative energy, gratitude, loving kindness, courage, wisdom or inspiration.
